(19) United States
(12) Patent Application Publication
(10) Pub. No.: US 2025/0108436 A1
(43) Pub. Date: Apr. 3, 2025

(54) SYSTEMS AND METHODS FOR CREATING A POWDER REMOVAL CAP VIA ADDITIVE MANUFACTURING

(71) Applicant: GM Global Technology Operations LLC, Detroit, MI (US)

(72) Inventors: Andrew Thomas Cunningham, Royal Oak, MI (US); Ante Tony Lausic, Burlington (CA); Adam Golembeski, Charlotte, NC (US); Patrick J. Eding, Fremont, MI (US)

(73) Assignee: GM Global Technology Operations LLC, Detroit, MI (US)

(21) Appl. No.: 18/476,717

(22) Filed: Sep. 28, 2023

(51) Int. Cl. B22F 10/73; B22F 10/68; B33Y 40/20

(52) U.S. Cl. CPC B22F 10/73; B22F 10/68; B33Y 40/20

(57) ABSTRACT

A method for capturing trapped powder from a part during an additive manufacturing process, the method comprising defining parameters for a part, the part defining an interior passageway defined by interior sidewalls, defining parameters for a powder removal cap, the powder removal cap comprising a body portion and a thin radial membrane connected to the interior sidewalls of the part, simultaneously creating the part and the powder removal cap via additive manufacturing, wherein the powder removal cap is created within the interior passageway and, upon completion of the creation of the part and the powder removal cap, the powder removal cap traps excess powder within the interior passageway, removing the powder removal cap from the interior passageway by breaking the radial membrane from the interior sidewalls to permit access to the interior passageway, and capturing the excess powder within the interior passageway.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against present disclosure.

The present disclosure relates generally to systems and methods for creating a powder removal cap via additive manufacturing.

Additive manufacturing (AM) (e.g., Laser Powder Bed Fusion (LPBF)) is expensive partly due to the high cost of materials. Fortunately, unfused powder can be reused if kept clean. Thus, reclaiming clean powder may create more positive AM business cases.

Certain die cast tools may use additively manufactured inserts/caps to improve quality and reduce scrap via conformal cooling channels. Such large AM parts are separated from a build plate after printing by using Electrical Discharge Machining (EDM). In some implementations, the AM parts may be fully immersed in a fluid, thereby safely containing otherwise airborne metal powder caused by the separation of the AM parts from the build plate via EDM.

When the insert is immersed in a fluid bath, however, the conformal line—which is filled with dry metal powder—becomes saturated with fluid. The fluid turns the metal powder into a sludge that is difficult to remove.

Accordingly, there is room for improvement for powder removal tools in parts created by additive manufacturing.

### SUMMARY

One aspect of the disclosure provides a method for capturing trapped powder from a part during an additive manufacturing process. The method comprises defining parameters for a part, the part defining an interior passageway defined by interior sidewalls, defining parameters for a powder removal cap, the powder removal cap comprising a body portion and a thin radial membrane connected to the interior sidewalls of the part, the body portion defining a socket, simultaneously creating the part and the powder removal cap via additive manufacturing, wherein the powder removal cap is created within the interior passageway and, upon completion of the creation of the part and the powder removal cap, the powder removal cap traps excess powder within the interior passageway, removing the powder removal cap from the interior passageway by engaging a tool with the socket and twisting the powder removal cap until the radial membrane breaks relative to the interior sidewalls to permit access to the interior passageway, and capturing the excess powder within the interior passageway.

Implementations of the disclosure include one or more of the following optional features. In some implementations, the socket is a hex socket and the tool is a hex key.

The part may be for a vehicle. The vehicle may be an automobile.

The radial membrane may include a notch and/or a perforation.

The part and the powder removal cap may be formed from the same material.

Another aspect of the disclosure provides a method for capturing trapped powder from a part during an additive manufacturing process. The method comprises defining parameters for a part, the part defining an interior passageway defined by interior sidewalls, defining parameters for a powder removal cap, the powder removal cap comprising a body portion and a thin radial membrane connected to the interior sidewalls of the part, simultaneously creating the part and the powder removal cap via additive manufacturing, wherein the powder removal cap is created within the interior passageway and, upon completion of the creation of the part and the powder removal cap, the powder removal cap traps excess powder within the interior passageway, removing the powder removal cap from the interior passageway by breaking the radial membrane from the interior sidewalls to permit access to the interior passageway, and capturing the excess powder within the interior passageway.

Implementations of the disclosure include one or more of the following optional features. In some implementations, the body portion defines a hex socket, and a hex key is used to twist the powder removal cap to break the radial membrane from the interior sidewalls.

The part may be for a vehicle. The vehicle may be an automobile.

The radial membrane may include a notch and/or a perforation.

The part and the powder removal cap may be formed from the same material.

Another aspect of the disclosure provides a method for capturing trapped powder from a part during an additive manufacturing process. The method comprises defining parameters for a part, the part defining an interior passageway, defining parameters for a powder removal cap, the powder removal cap comprising a thin radial membrane disposed within the interior passageway of the part, simultaneously creating the part and the powder removal cap via additive manufacturing, wherein, upon completion of the creation of the part and the powder removal cap, the powder removal cap traps excess powder within the interior passageway, removing the powder removal cap from the interior passageway by breaking the radial membrane to permit access to the interior passageway, and capturing the excess powder within the interior passageway.

Implementations of the disclosure include one or more of the following optional features. In some implementations, the powder removal cap includes a body portion defining a hex socket, and a hex key is used to twist the powder removal cap to break the radial membrane.

The part may be for a vehicle. The vehicle may be an automobile.

The radial membrane may include a notch and/or a perforation.

The details of one or more implementations of the disclosure are set forth in the accompanying drawings and description below. Other aspects, features, and advantages will be apparent from the description and drawings, and from the claims.

### BRIEF DESCRIPTION OF THE DRAWINGS

The drawings described herein are for illustrative purposes only of selected configurations and are not intended to limit the scope of the present disclosure.

FIG. 1 is a perspective view of an exemplary powder removal cap disposed within an exemplary part, in accordance with the teachings of the present disclosure;

FIG. 2A is a magnified view of the powder removal cap of FIG. 1;

FIG. 2B is a cross-sectional perspective view of the powder removal cap taken along lines 2B-2B of FIG. 2A;

FIG. 2C is a cross-sectional plan view of the powder removal cap of FIG. 2A;

FIG. 2D is a magnified view of a portion of the powder removal cap of FIG. 2B;

FIG. 3A is a plan view of a bottom of the powder removal cap having a radial membrane including perforations of FIG. 1;

FIG. 3B is a plan view of a bottom of the powder removal cap having a radial membrane including a notch of FIG. 1;

FIG. 4A is a perspective view of an exemplary part including the powder removal cap;

FIG. 4B is a magnified view of a portion of FIG. 4A;

FIG. 4C is a partial cross-sectional view of the exemplary part and powder removal cap taken along lines 4C-4C of FIG. 4B; and

FIG. 5 is a flowchart detailing a process for creating the exemplary powder removal caps and parts of FIGS. 1-4C, in accordance with the teachings of the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

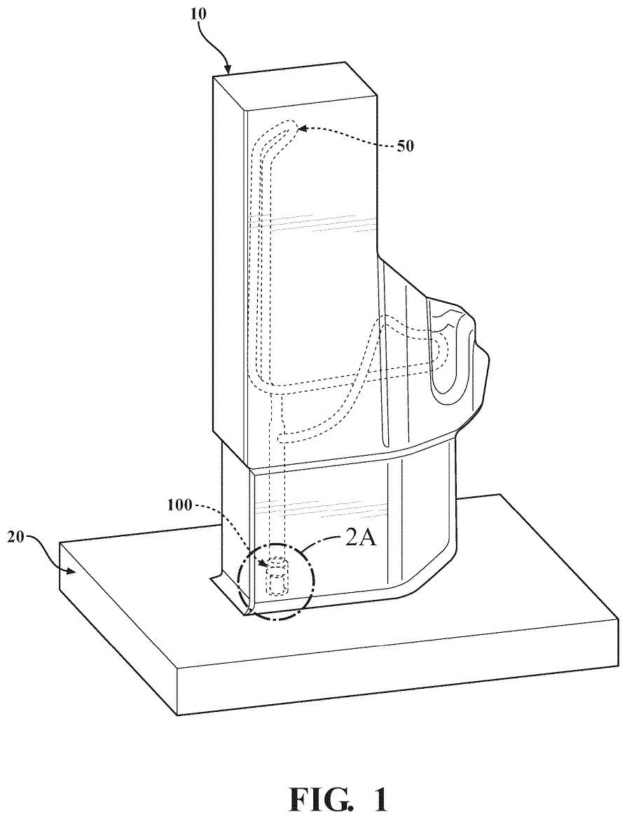

Referring to FIG. 1, a powder removal cap 100 is generally shown in an interior passageway or conformal cooling line 50 of a part or die insert 10 on a build plate 20. As will become apparent, the part 10 and the powder removal cap 100 are simultaneously created using additive manufacturing (AM). The part 10 and the powder removal cap 100 may be created using any suitable material (e.g., titanium alloys, cobalt chromium, stainless steel, nickel alloys, aluminum alloys, etc.) and any suitable AM process (e.g., Laser Powder Bed Fusion (LPBF)).

The part 10 may be a part for a vehicle, which may be an automobile. As will be appreciated, the vehicle may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles in certain configurations. The vehicle may also comprise a truck, a watercraft, an aircraft, and/or one or more other types of vehicles.

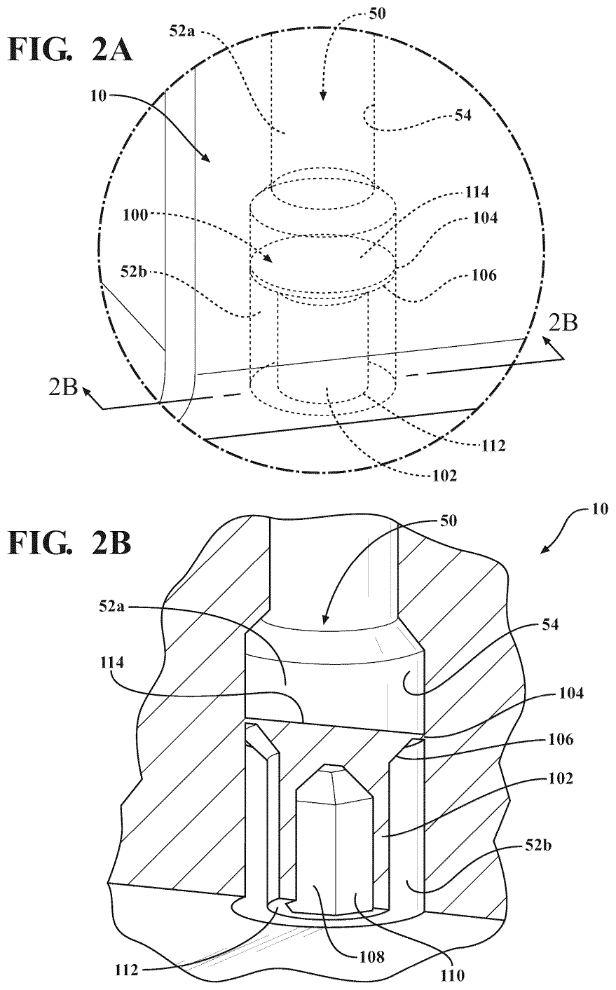

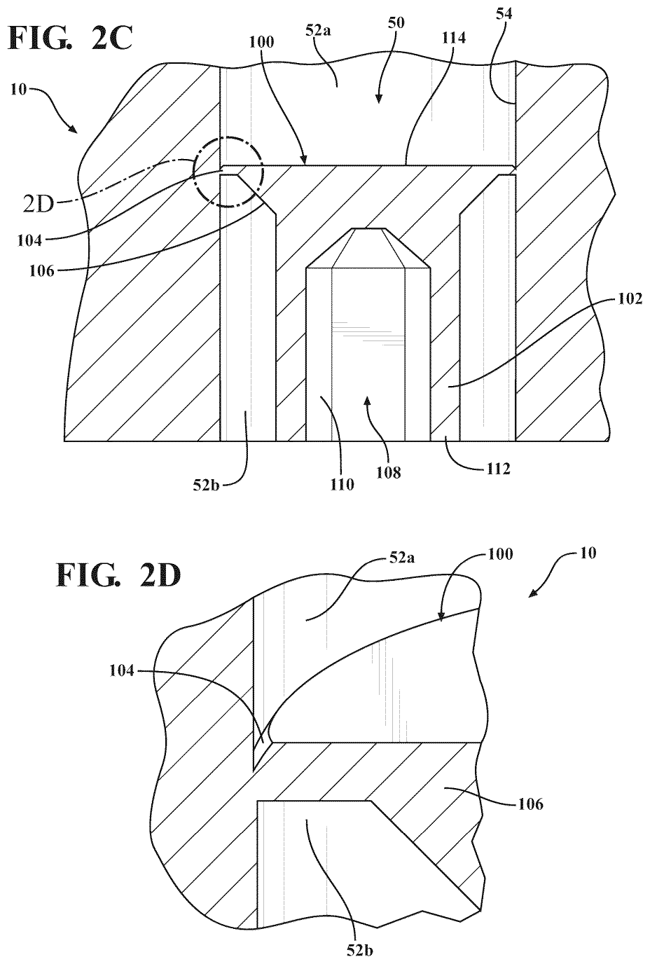

Referring to FIGS. 2A-2D, the interior passageway 50 of the part 10 includes an upper passageway 52a and a lower passageway 52b. Upon completion of the AM process, the upper passageway 52a contains excess dry powder resultant from the AM process and the lower passageway 52b includes powder sludge resultant from excess dry powder from the AM process mixing with liquid when the part 10 and powder removal cap 100 are cut from the build plate 20. The interior passageway 50 is defined by interior sidewalls 54, which, as shown in FIGS. 1-2D, may form a generally cylindrical shape.

The powder removal cap 100 includes a body portion 102, which may comprise a generally cylindrical shape or any other suitable shape. The powder removal cap 100 includes a thin radial membrane 104 connected to the body portion 102 by a flange portion 106. The diameter of the body portion 102 may be less than the diameter of the radial membrane 104. The radial membrane 104 may be created such that it is attached to the interior sidewalls 54 of the interior passageway 50 and may be a thin portion of material, e.g., between approximately 0.1 mm and 0.5 mm. The thickness of the radial membrane 104 may be adjusted to any suitable thickness to allow the radial member 104 to break from the interior sidewalls 54 upon a sufficient torque force.

The body portion 102 includes socket sidewalls 110 defining a socket 108. In some implementations, the socket 108 is hex-shaped. In other implementations, the socket 108 may be threaded, splined, or have any other suitable configuration, such as Philips head, Robertson head, flat head, etc. The socket 108 is configured to receive any suitable tool, such as a hex key, a Philips head screwdriver, a Robertson head screwdriver, a flat head screwdriver, etc. The powder removal cap 100 extends from a bottom surface 112 that is cut from the build plate 20 to a top surface that is adjacent the upper passageway 52a of the interior passageway 50.

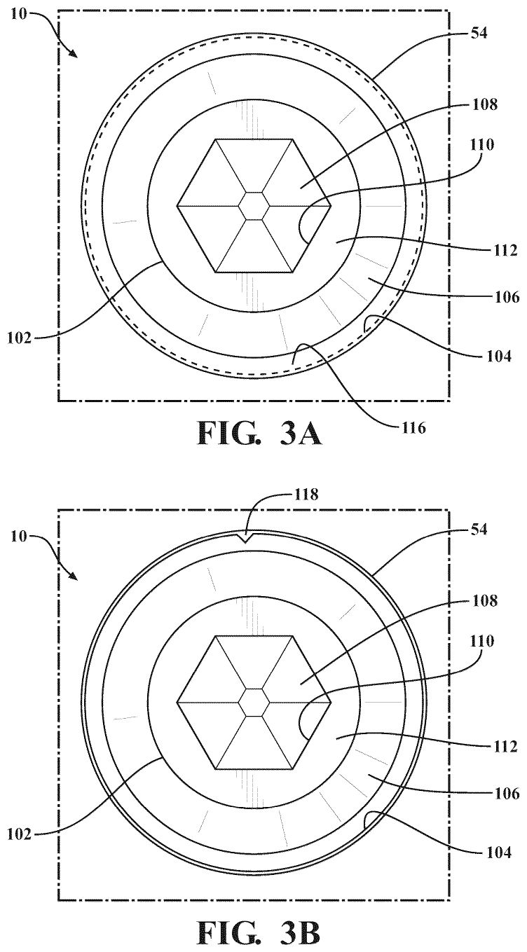

Referring to FIG. 3A, in some implementations, the radial member 104 may include one or more perforations 116 at or near the connection with the interior sidewalls 54. The perforations 116 may be thinner layers of material than the radial membrane 104 or may be gaps in the material of the radial membrane 104. The perforations 116 may function to weaken the radial membrane 104 to reduce the torque force required to break the radial membrane 104 from the interior sidewalls 54.

Referring to FIG. 3B, in some implementations, the radial membrane 104 may include a notch 118 at or near the connection with the interior sidewalls 54. The notch 118 may be a thinner layer of material than the radial membrane 104 or may be a gap in the material of the radial membrane 104. The notch 118 may function to weaken the radial membrane 104 to reduce the torque force required to break the radial membrane 104 from the interior sidewalls 54.

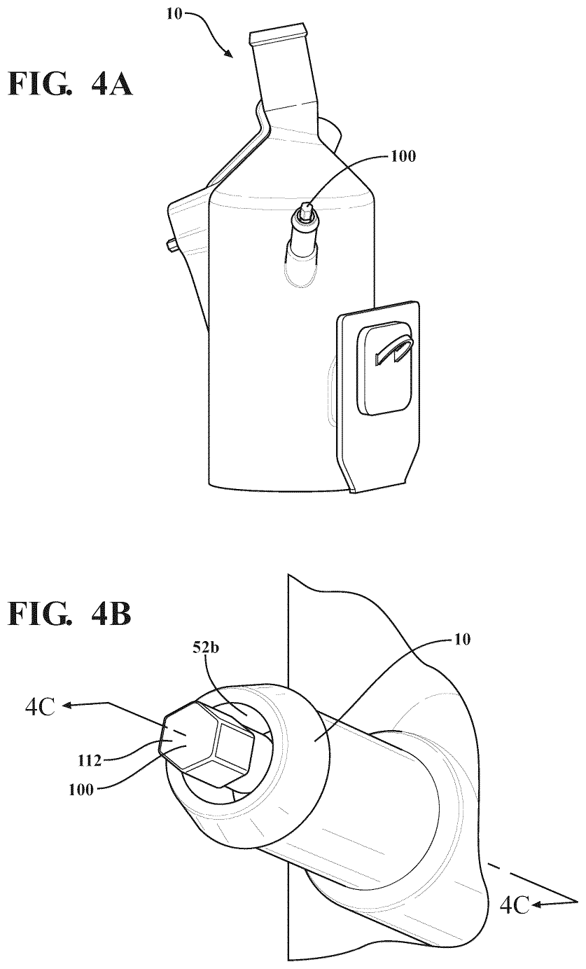

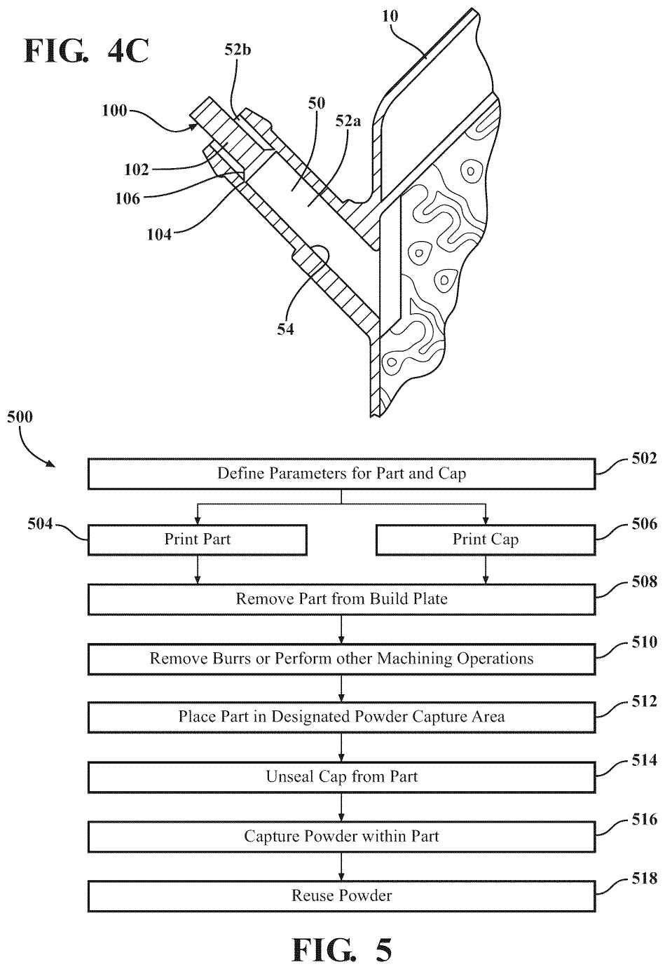

Referring to FIG. 4A, in some implementations, the powder removal cap 100 may include a body portion 102 without a socket 108. Instead, the body portion 102 may be shaped as a hexagon or any other suitable shape to receive, e.g., a hex socket, or any other suitable tool to twist or torque the powder removal cap 100.

Referring to FIG. 5, a method 500 for capturing trapped powder from the part 10 during an AM process is generally shown. The method 500 includes a first step 502, whereby a computer system or any other suitable machine defines parameters for the part 10 and the powder removal cap 100. At steps 504 and 506, an AM machine simultaneously prints the part 10 and the powder removal cap 100 within the interior passageway 50. At step 508, the part 10 and powder removal cap 100 are removed from the build plate 20 via any suitable process, e.g., Electrical Discharge Machining (EDM). At step 510, any suitable machining operations may be performed to, e.g., remove burrs from the part 10 and the powder removal cap 100.

At step 512, the part 10 may be moved to a designated area to capture the powder. For example, the part 10 may be moved to a location with a recycling bin or other suitable capturing device under the interior passageway 50. At step 514, the powder removal cap 100 may be separated from the interior sidewalls 54 of the interior passageway 50. For example, a hex key may be inserted into the socket 108 and the hex key may be twisted until the torque force causes the radial membrane 104 to break from the interior sidewalls 54. At step 516, the excess powder within the interior passageway 50 may be captured in the recycling bin or other suitable capturing device. In some implementations, a vacuum, blower, or any other suitable mechanism may be used to facilitate retrieval of the powder from the interior passageway 50. At step 518, the powder may be reused for additional AM processes.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A method for capturing trapped powder from a part during an additive manufacturing process, the method comprising:
defining parameters for a part, the part defining an interior passageway defined by interior sidewalls;
defining parameters for a powder removal cap, the powder removal cap comprising a body portion and a thin radial membrane connected to the interior sidewalls of the part, the body portion defining a socket;
simultaneously creating the part and the powder removal cap via additive manufacturing, wherein the powder removal cap is created within the interior passageway and, upon completion of the creation of the part and the powder removal cap, the powder removal cap traps excess powder within the interior passageway;
removing the powder removal cap from the interior passageway by engaging a tool with the socket and twisting the powder removal cap until the radial membrane breaks relative to the interior sidewalls to permit access to the interior passageway; and
capturing the excess powder within the interior passageway.

2. The method of claim 1, wherein the socket is a hex socket and the tool is a hex key.

3. The method of claim 1, wherein the part is for a vehicle.

4. The method of claim 3, wherein the vehicle is an automobile.

5. The method of claim 1, wherein the radial membrane includes a notch.

6. The method of claim 1, wherein the radial membrane includes a perforation.

7. The method of claim 1, wherein the part and the powder removal cap are formed from the same material.

8. A method for capturing trapped powder from a part during an additive manufacturing process, the method comprising:
defining parameters for a part, the part defining an interior passageway defined by interior sidewalls;
defining parameters for a powder removal cap, the powder removal cap comprising a body portion and a thin radial membrane connected to the interior sidewalls of the part;
simultaneously creating the part and the powder removal cap via additive manufacturing, wherein the powder removal cap is created within the interior passageway and, upon completion of the creation of the part and the powder removal cap, the powder removal cap traps excess powder within the interior passageway;
removing the powder removal cap from the interior passageway by breaking the radial membrane from the interior sidewalls to permit access to the interior passageway; and
capturing the excess powder within the interior passageway.

9. The method of claim 8, wherein the body portion defines a hex socket, and a hex key is used to twist the powder removal cap to break the radial membrane from the interior sidewalls.

10. The method of claim 8, wherein the part is for a vehicle.

11. The method of claim 10, wherein the vehicle is an automobile.

12. The method of claim 8, wherein the radial membrane includes a notch.

13. The method of claim 8, wherein the radial membrane includes a perforation.

14. The method of claim 8, wherein the part and the powder removal cap are formed from the same material.

15. A method for capturing trapped powder from a part during an additive manufacturing process, the method comprising:
defining parameters for a part, the part defining an interior passageway;
defining parameters for a powder removal cap, the powder removal cap comprising a thin radial membrane disposed within the interior passageway of the part;
simultaneously creating the part and the powder removal cap via additive manufacturing, wherein, upon completion of the creation of the part and the powder removal cap, the powder removal cap traps excess powder within the interior passageway;
removing the powder removal cap from the interior passageway by breaking the radial membrane to permit access to the interior passageway; and
capturing the excess powder within the interior passageway.

16. The method of claim 15, wherein the powder removal cap includes a body portion defining a hex socket, and a hex key is used to twist the powder removal cap to break the radial membrane.

17. The method of claim 15, wherein the part is for a vehicle.

18. The method of claim 17, wherein the vehicle is an automobile.

19. The method of claim 15, wherein the radial membrane includes a notch.

20. The method of claim 15, wherein the radial membrane includes a perforation.
